(19) United States
(12) Patent Application Publication
(10) Pub. No.: US 2019/0285128 A1
(43) Pub. Date: Sep. 19, 2019

(54) One-Way Overrunning Alternator Clutch

(71) Applicant: ALT AMERICA INC., Westland, MI (US)

(72) Inventors: Josh Cooley, Ashland, KY (US); Gang S. Chen, Huntington, WV (US)

(21) Appl. No.: 15/920,561

(22) Filed: Mar. 14, 2018

(51) Int. Cl. F16D 41/20; F16D 45/00

(52) U.S. Cl. CPC F16D 41/203; F16D 45/00

(57) ABSTRACT

A one-way overrunning alternator clutch includes a shaft that includes a flange disposed at a first end of the shaft. The one-way overrunning alternator clutch also includes an axle extending from a first side of the flange to a second end of the shaft and a spring set that engages the flange of the shaft. The shaft includes a first spring, a second spring, and a third spring. The one-way overrunning alternator clutch also includes a first retainer engaging the spring set, and a pulley that includes an inner bore that receives the shaft, the spring set, and the retainer.

### TECHNICAL FIELD

This disclosure relates to one-way overrunning alternator clutches.

### BACKGROUND

Vehicle engines, such as internal combustion engines, typically include an alternator that, when driven by a pulley of the vehicle engine, provides electrical power to components of the vehicle. For example, the alternator may provide electrical power to a battery of the vehicle, which may charge the battery. As the vehicle engine operates, a mechanical load may be transferred to the alternator and pulley, which may be referred to as an alternator-pulley system.

Increasingly, modern vehicles require more electrical power to operate various electrical components of the vehicle. This may result in an increased load placed on components of the vehicle engine, such as the alternator-pulley system. The increased load placed on the alternator-pulley system can lead to belt slip, undesirable vibration, and noise, which may increase wear of the alternator and/or other components and may decrease the useful lifetime of the alternator-pulley system. Further, other sources of vibration within an engine may add to the vibration caused by the pulley, which may cause the pulley and/or an alternator rotor associated with the alternator to run irregularly. This irregular running of the pulley and/or alternator rotor may decrease the operating efficiency of the alternator-pulley system.

### SUMMARY

Disclosed herein are implementations of one-way overrunning alternator clutches.

An aspect of the disclosed embodiments is a one-way overrunning alternator clutch for reducing vibration and noise associated with a vehicle engine. The one-way overrunning alternator clutch comprises: a first retainer that comprises an inner bore extending through the first retainer; a shaft that comprises a flange disposed at a first end of the shaft; an axle extending from a first side of the flange to a second end of the shaft, the second end of the shaft being opposed to the first end of the shaft, wherein the axle is adapted to be received by the inner bore of the first retainer; a first spring that comprises: a first end that engages a first spring seat aperture disposed on a first side of the first retainer; a second end that engages a second spring seat aperture disposed on a second side of the flange; and an inner bore extending from the first end of the second spring to the second end of the second spring that receives the axle of the shaft; a second spring that comprises: a first end that engages a first recess disposed on the first side of the first retainer; a second end that engages a second recess disposed on the second side of the flange; and an inner bore extending from the first end of the first spring to the second end of the first spring that receives the first spring; and a third spring that comprises: a first end that engages a third spring seat aperture disposed on the first side of the first retainer; a second end that engages the second side of the flange; and an inner bore extending from the first end of the third spring to the second end of the third spring that receives the first spring.

Another aspect of the disclosed embodiments is a clutch that comprises: a first retainer that comprises an inner bore extending through the first retainer; a shaft that comprises a flange disposed at a first end of the shaft; an axle extending from a first side of the flange to a second end of the shaft, the second end of the shaft being opposed to the first end of the shaft, wherein the axle is received by the inner bore of the first retainer; and a spring set disposed between the first retainer and the flange of the shaft, comprising: a first spring that receives the axle and comprises a first end that engages a first spring seat aperture disposed on the first side of the first retainer, the first spring being rotatable about the axle and having a coil diameter that is selectively adjustable between a first diameter and a second diameter that is larger than the first diameter; a second spring that receives the first spring, the second spring having a coil diameter that is selectively adjustable between a third diameter and a fourth diameter, wherein the fourth diameter is larger than the third diameter; and a third spring that comprises a first end that engages a second spring seat aperture disposed on the first side of the first retainer, and an inner bore that receives the second spring.

Another aspect of the disclosed embodiments is a system that comprises: a first retainer that comprises an inner bore extending through the first retainer; a shaft that comprises a flange disposed at a first end of the shaft; an axle extending from a first side of the flange to a second end of the shaft, the second end of the shaft being opposed to the first end of the shaft, wherein the axle is received by the inner bore of the first retainer; a second retainer disposed on a second side of the first retainer, opposite the first side, that comprises: a stopper disposed on a first side of the second retainer that engages a portion of the second side of the first retainer, wherein the stopper limits a relative rotation of the first retainer and the second retainer; and an inner bore that is adapted to receive the axle; a bearing disposed on a second side of the second retainer, opposite the first side, that comprises an inner bore that receives the axle; a pulley that comprises an inner bore extending through the pulley, wherein the inner bore receives the shaft, the first retainer, the second retainer, and the bearing; and a spring set disposed between the first retainer and the shaft, comprising: a first spring that receives the axle and comprises a first end that engages a first spring seat aperture disposed on the first side of the first retainer, the first spring being rotatable about the axle and having a coil diameter that is selectively adjustable between a first diameter and a second diameter that is larger than the first diameter, wherein the coil diameter of the first spring is adjusted from the second diameter to the first diameter in response to the relative rotation of the shaft and the pulley being in a first direction; a second spring that receives the first spring, the second spring having a coil diameter that is selectively adjustable between a third diameter and a fourth diameter that is larger than the third diameter, wherein the coil diameter of the second spring is adjusted from the third diameter to the fourth diameter in response to the relative rotation of the shaft and the pulley being in the first direction; and a third spring that comprises a first end that engages a second spring seat aperture disposed on the first side of the first retainer, and an inner bore that receives the second spring, wherein the third spring is adapted to engage the inner bore of the pulley in response to the second spring being in the fourth diameter.

Variations in these and other aspects, features, elements, implementations, and embodiments of the methods, apparatus, procedures, and algorithms disclosed herein are described in further detail hereinafter.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 generally illustrates an example of a one-way overrunning alternator clutch assembly according to the principles of the present disclosure.

FIGS. 2A-2B generally illustrate a shaft according to the principles of the present disclosure.

FIGS. 3A-3B generally illustrate a pulley including a washer according to the principles of the present disclosure.

FIG. 4 generally illustrates a spring according to the principles of the present disclosure.

FIGS. 5A-5B generally illustrate a spring according to the principles of the present disclosure.

FIGS. 6A-6B generally illustrate a spring according to the principles of the present disclosure.

FIGS. 7A-7B generally illustrate a retainer according to the principles of the present disclosure.

FIG. 8 generally illustrates a retainer according to the principles of the present disclosure.

FIG. 9 generally illustrates a bearing according to the principles of the present disclosure.

FIG. 10 generally illustrates an exploded view of the one-way overrunning alternator clutch assembly of FIG. 1.

### DETAILED DESCRIPTION

A vehicle typically utilizes electrical power in order to control ignition components and/or other electronic components associated with the vehicle. A vehicle engine, such as a spark-ignition internal combustion engine, or other suitable engine, includes an alternator-pulley system. As the engine operates, the engine drives a belt associated with the alternator-pulley system, which drives an alternator of the alternator-pulley system. The alternator provides electrical power to a battery of the vehicle. The electrical power may charge the battery. The battery may be used to supply electrical power to ignition components of the vehicle during vehicle startup. The vehicle engine and/or components of the alternator-pulley system may produce undesirable vibration and/or noise while the engine and the alternator-pulley system operate. As the amount of electrical power utilized by a modern vehicle has increased, alternator loads and engine torsional fluctuations have increased accordingly. As a result, it may be desirable to utilize an alternator-pulley system that includes relatively higher decoupling capabilities, a relatively higher damping ratio, and relatively greater flexibility than is characteristic of typical alternator-pulley systems, which may reduce vibration and/or noise generated by the alternator-pulley system. This may prolong the life of the alternator-pulley system and/or the vehicle engine, while increasing an efficiency of power transmission from the vehicle engine to the alternator.

In some embodiments according to the principles of the present disclosure, an alternator-pulley system includes a one-way overrunning alternator clutch. A one-way overrunning alternator clutch is adapted to transmit torque from the vehicle engine to the alternator through the one-way overrunning alternator clutch in response to an acceleration of the vehicle engine. The one-way overrunning alternator clutch is adapted to decouple the alternator from the pulley when the alternator overruns the pulley (e.g., when an angular velocity of the alternator is higher than an angular velocity of the pulley). As will be described, the one-way overrunning alternator clutch reduces and/or controls vibration and/or noise generated by the vehicle engine and/or the alternator-pulley system. Additionally, or alternatively, the one-way overrunning alternator clutch can reduce and/or control belt jitter, increase power transmission efficiency of a battery charging system associated with the battery, and/or prolong the operating life of components of the alternator-pulley system and/or other components associated with the vehicle engine.

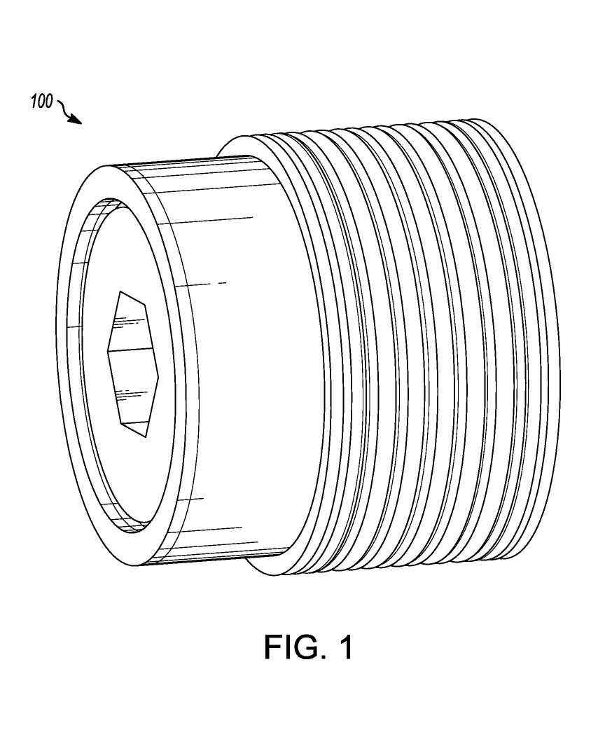

FIG. 1 generally illustrates an example of a one-way overrunning alternator clutch assembly 100 according to the principles of the present disclosure. The one-way overrunning alternator clutch assembly 100 can be associated with a vehicle engine, such as a spark-ignition internal combustion engine, or other suitable engine, as described above. The one-way overrunning alternator clutch assembly 100 transmits torque from the engine to an alternator associated with the engine when the engine speed increases, and decouples the engine from the alternator when the engine speed decreases. Additionally, or alternatively, the one-way overrunning alternator clutch assembly 100 may reduce, inhibit, and/or eliminate vibration and/or noise associated with an alternator-pulley system and/or other components of the vehicle engine.

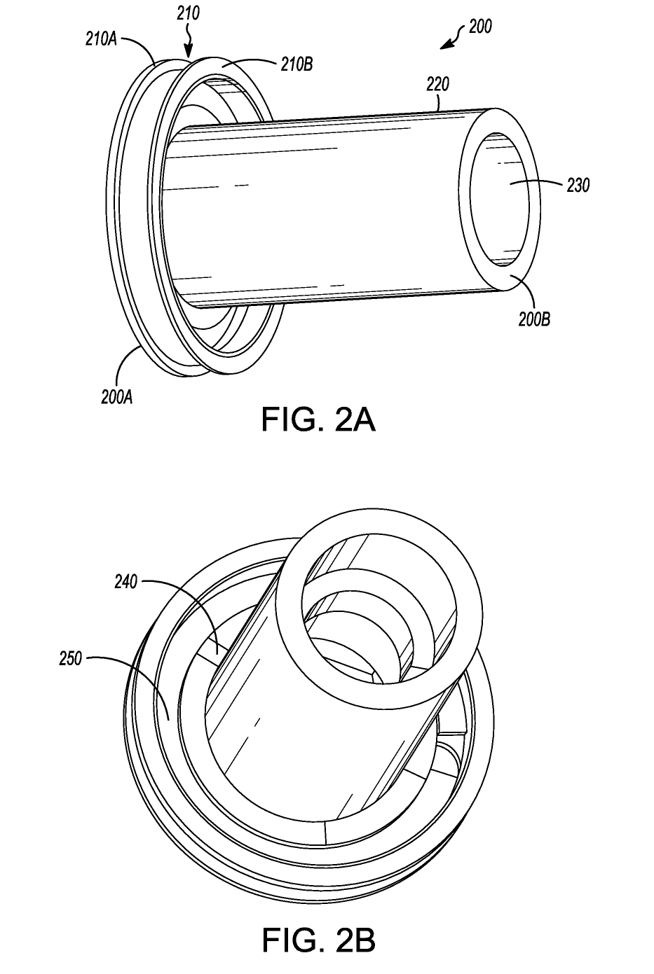

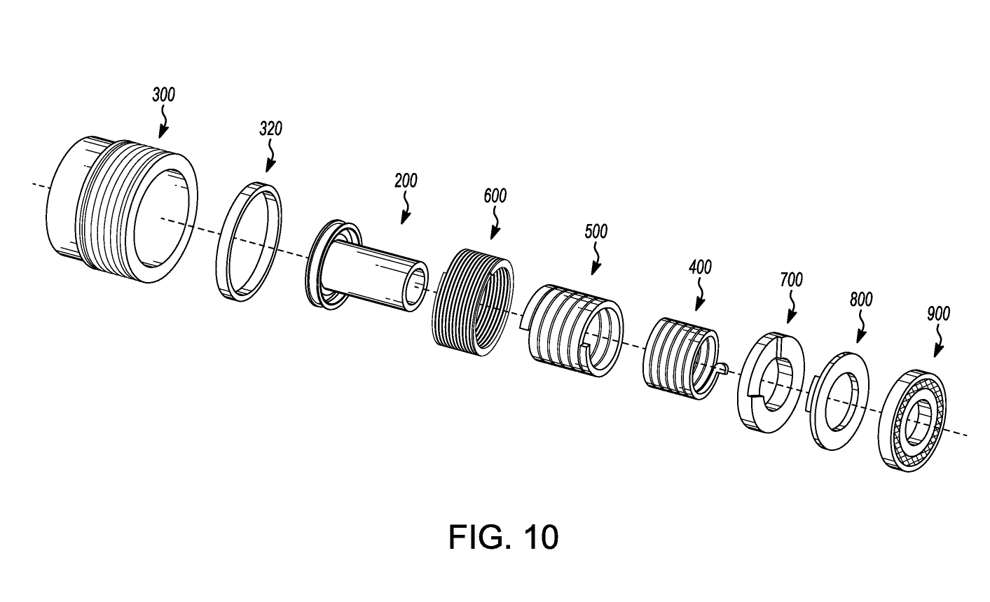

In some embodiments, and as is generally illustrated in FIG. 10, the one-way overrunning alternator clutch assembly 100 includes a shaft 200, a pulley 300, a first spring 400, a torsional spring 500, a second spring 600, a washer 320, a first retainer 700, a second retainer 800, and a bearing 900. As is generally illustrated in FIGS. 2A and 2B, the shaft 200 includes a flange 210, an axle 220, an inner bore 230, a spring seat aperture 240, and a recess 250. The flange 210 is disposed at a first end 200A of the shaft 200. A first side 210A of the flange 210 is disposed proximate the first end 200A of the shaft 200. A second side 210B is disposed on the flange 210 opposite the first side 210A. The shaft 200 includes a second end 200B disposed opposite the first end 200A. The axle 220 extends from the first side 210A of the flange 210 to the second end 200B of the shaft 200. The inner bore 230 extends through a central or substantially central portion of the axle 220 from the first end 200A of the shaft 200 to the second end 200B of the shaft 200.

The spring seat aperture 240 is disposed proximate the second side 210B of the flange 210. For example, the second side 210B of the flange 210 includes a recess that includes an arcuate or substantially arcuate profile, or other suitable profile. The spring seat aperture 240 is disposed on an end of the recess. For example, the recess can be axially disposed around at least a portion of an inner circumferential profile of the second side 210B of the flange 210, and the end of the recess can be a profile vertical to the arcuate or substantially arcuate profile of the recess.

The recess 250 is axially disposed around at least a portion of an inner circumferential profile of the second side 210B of the flange 210. For example, the recess 250 includes an arcuate or substantially arcuate profile that extends around the inner circumferential profile of the second side 210B.

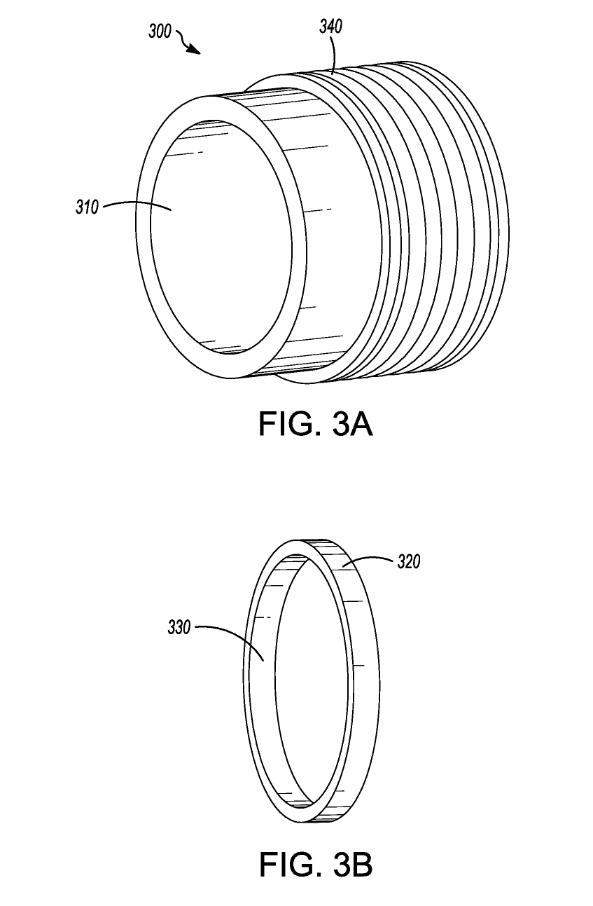

In some embodiments, the one-way overrunning alternator clutch assembly 100 includes a pulley 300 including a washer 320, as is generally illustrated in FIGS. 3A and 3B. The pulley 300 includes an inner bore 310 that extends from a central or substantially central portion of a first end of the pulley 300A to a second end of the pulley 300B. In some embodiments, the outer surface of the pulley 300 includes one or more grooves 340 that are adapted to engage the belt, which is mechanically coupled to the engine.

In some embodiments, the pulley 300 includes a washer 320. An outer profile of the washer 320 is defined by the inner profile of the inner bore 310. The washer 320 is adapted to be received by the inner bore 310. For example, the washer 320 is adapted to be press-fitted into the inner bore 310. In some embodiments, the washer 320 includes an inner bore 330 that is adapted to receive a portion of the flange 210. For example, the flange 210 may be press-fitted into the inner bore 330. The washer 320 is adapted to rotate about the flange 210 when the flange 210 is received by the inner bore 330.

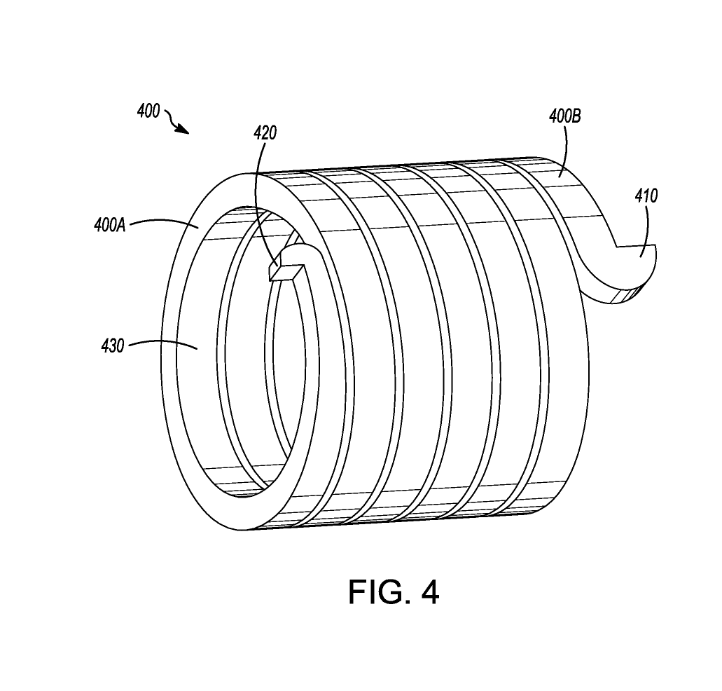

In some embodiments, the one-way overrunning alternator clutch assembly 100 includes a first spring 400, as is generally illustrated in FIG. 4. The first spring 400 includes an inner bore 430 that extends from a first side 400A of the first spring 400 to a second side 400B of the first spring 400. The inner bore 430 is defined by the inner profile of the coil of the first spring 400. The second side 400B is disposed opposite the first side 400A. A first stopper 420 is disposed proximate the first side 400A. A second stopper 410 is disposed proximate the second side 400B. The first stopper 420 is adapted to engage the second side 210B of the flange 210. For example, the first stopper 420 is inserted into the spring seat aperture 240 disposed on the second side 210B of the flange 210. The inner bore 430 is adapted to receive the axle 220. For example, the axle 220 can be press-fitted into the first spring 400. In some embodiments, the first spring 400 can be a torsional spring coiled around the axle 220 or other suitable springs.

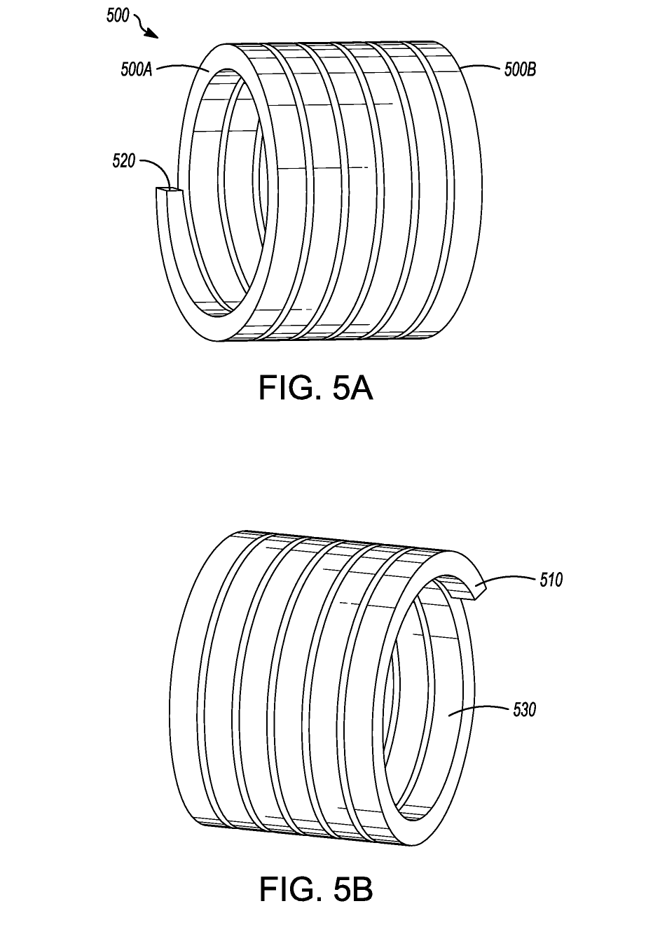

The one-way overrunning alternator clutch assembly 100 includes a torsional spring 500, as is generally illustrated in FIGS. 5A and 5B. The torsional spring 500 includes an inner bore 510 that extends from a first side 500A of the torsional spring 500 to a second side 500B of the torsional spring 500. The inner bore 510 is defined by the inner profile of the coil of the torsional spring 500. The second side 500B is disposed opposite the first side 500A. The first side 500A is adapted to engage the second side 210B of the flange 210. For example, the first side 500A can fit snugly into the recess 250 disposed on the second side 210B. The inner bore 510 is adapted to receive the first spring 400. For example, the first spring 400 can be press-fitted into the inner bore 510. The torsional spring 500 and the first spring 400, respectively, are wound in opposite directions. For example, the first spring 400 can be wound up in a clockwise direction and the torsional spring 500 may be wound up in a counter-clockwise direction. However, it should be understood that the principles of the present disclosure also apply to the first spring 400 being wound up in a counter-clockwise direction and the torsional spring 500 being wound up in a clockwise direction.

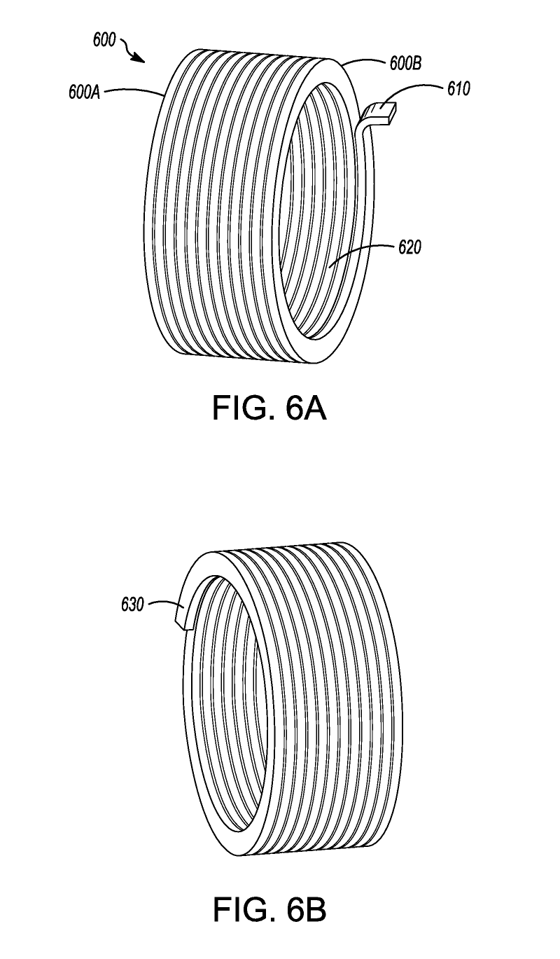

The one-way overrunning alternator clutch assembly 100 includes a second spring 600, as is generally illustrated in FIGS. 6A and 6B. The second spring 600 includes an inner bore 620 that extends from a first side 600A of the second spring 600 to a second side 600B of the second spring 600. The inner bore 620 is defined by the inner profile of the coil of the second spring 600. The second side 600B is disposed opposite the first side 600A. The first side 600A is adapted to engage the second side 210B of the flange 210. For example, the first side 600A can be pressed against the second side 210B and can slide freely on the second side 210B. A stopper 610 is disposed proximate the second side 600B. The inner bore 620 is adapted to receive the outer profile of the torsional spring 500. For example, an initial coil diameter associated with the second spring 600 is larger than the initial coil diameter of the torsional spring 500, such that the torsional spring 500 can be inserted and/or press-fitted into the inner bore 620. The second spring 600 is wound up in the same direction as the first spring 400 is and, accordingly, in the opposite direction of the torsional spring 500. In some embodiments, for example, the first spring 400 can be wound up in a clockwise direction, whereas the torsional spring 500 can be wound up in a counter-clockwise direction, and the second spring 600 is thus also wound up in a clockwise direction.

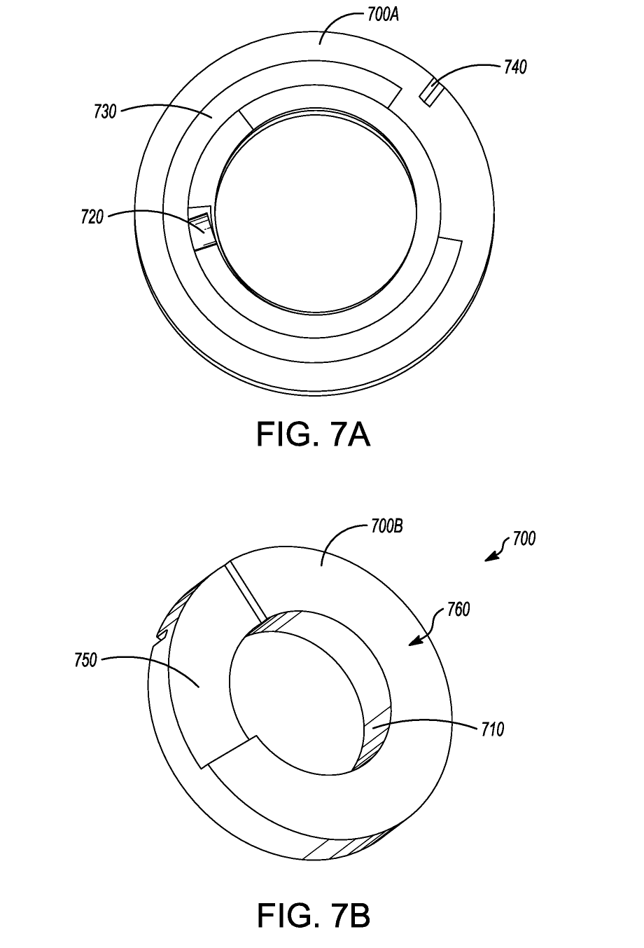

The one-way overrunning alternator clutch assembly 100 includes a first retainer 700, as is generally illustrated in FIGS. 7A and 7B. The first retainer 700 includes an inner bore 710, a first spring seat aperture 720, a recess 730, a second spring seat aperture 740, and a stopper 750. The inner bore 710 extends from a first side 700A of the first retainer 700 to a second side 700B of the first retainer 700. The inner bore 710 is adapted to receive a portion of the axle 220. For example, the axle 220 can be press-fitted into the inner bore 710, such that the outer profile of the axle 220 can fit snugly within the inner bore 710.

The first spring seat aperture 720 is disposed at the first side 700A of the first retainer 700. For example, the first side 700A of the first retainer 700 includes a recess that includes an arcuate or substantially arcuate profile, or other suitable profile. The first spring seat aperture 720 is disposed on an end of the recess. For example, the recess can be axially disposed around at least a portion of an inner circumferential profile of the first side 700A of the first retainer 700, and the end of the recess can be a profile vertical to the arcuate or substantially arcuate profile of the recess. The first side 700A of the first retainer 700 is adapted to engage the second side 400B of the first spring 400. For example, the first spring seat aperture 720 disposed on the first side 700A is adapted to engage the second stopper 410 disposed on the second side 400B of the first spring 400 (e.g., the second stopper 410 is inserted into the first spring seat aperture 720).

The recess 730 is disposed on the first side 700A of the retainer. For example, the recess 730 can be axially disposed around at least a portion of an inner circumferential profile of the first side 700A of the first retainer 700. In some embodiments, the recess 730 includes an arcuate or substantially arcuate profile that extends around the inner circumferential profile of the first side 700A of the first retainer 700. The first side 700A of the first retainer 700 is adapted to engage the second side 500B of the torsional spring 500. For example, the second side 500B of the torsional spring 500 can fit snugly into the recess 730 disposed on the first side 700A of the first retainer 700.

The second spring seat aperture 740 is disposed on the first side 700A of the first retainer 700. The first side 700A of the first retainer 700 is adapted to engage the second side 600B of the second spring 600. For example, the second spring seat aperture 740 disposed on the first side 700A is adapted to engage the stopper 610 disposed on the second side 600B of the second spring 600 (e.g., the stopper 610 is inserted into the second spring seat aperture 740).

The stopper 750 is disposed on the second side 700B of the first retainer 700. The stopper 750 includes a first end 750A and a second end 750B.

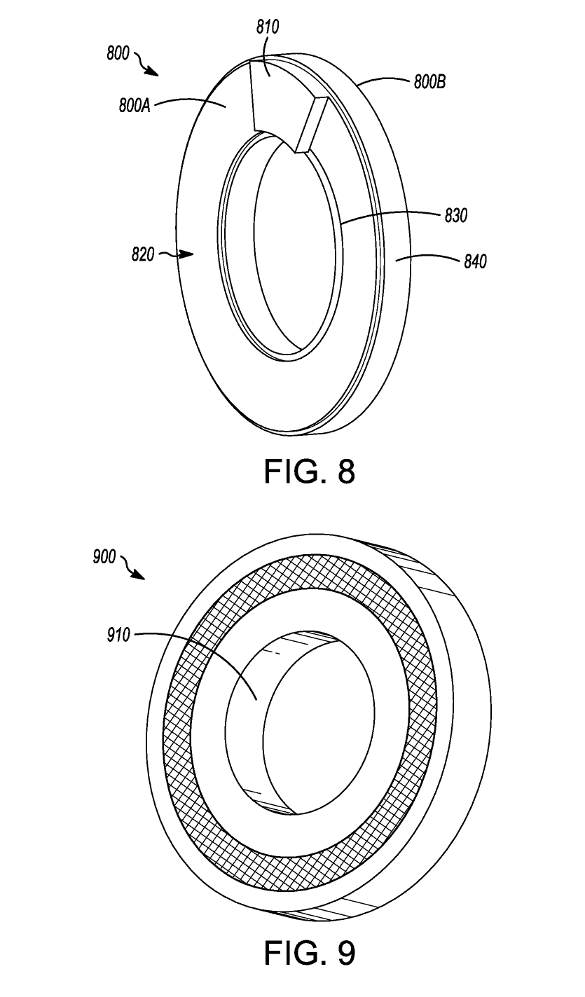

The one-way overrunning alternator clutch assembly 100 includes a second retainer 800 as is generally illustrated in FIG. 8. The second retainer 800 includes an inner bore 810 and a stopper 820. The inner bore 810 extends through the second retainer 800 and is adapted to receive the axle 220 of the shaft 200. For example, the axle 220 is press-fitted into the inner bore 810, such that the outer profile of the axle 220 fits snugly within the inner bore 810. The stopper 820 is disposed on a first side 800A of the second retainer 800. The stopper 820 is adapted to engage the stopper 750 that is disposed on the second side 700B of the first retainer 700, so that a relative rotation between the first retainer 700 and the second retainer 800 is limited. For example, the stopper 820 can fit snugly into the stopper 750. The width between the first end 750A of the stopper 750 and the second end 750B of the stopper 750 is equal to or wider than the width of the stopper 820, such that the stopper 820 is rotatable relative to the first retainer 700 within the range between the first end 750A and the second end 750B.

The one-way overrunning alternator clutch assembly 100 includes a bearing 900 that includes an inner bore 910 as is generally illustrated in FIG. 9. For example, the bearing 900 can be a self-lubricating bearing or other suitable bearing. The inner bore 910 extends through the bearing 900 and is adapted to receive the axle 220 of the shaft 200. For example, the axle 220 is press-fitted into the inner bore 910, such that the outer profile of the axle 220 fits snugly within the inner bore 910.

FIG. 10 generally illustrates an exploded view of the one-way overrunning alternator clutch assembly 100 that includes the pulley 300, the washer 320, the shaft 200, the second spring 600, the torsional spring 500, the first spring 400, the first retainer 700, the second retainer 800, and the bearing 900. As described above, the inner bore 310 of the pulley 300 is adapted to receive the shaft 200, the second spring 600, the torsional spring 500, the first spring 400, the first retainer 700, the second retainer 800, and the bearing 900. For example, the first retainer 700, the second retainer 800, and the bearing 900 are inserted into a first side of the pulley 300. The second side 800B of the second retainer 800 engages the bearing 900. The stopper 750 engages the stopper 820. The second spring 600 receives the outer profile of the torsional spring 500. The torsional spring 500 receives the outer profile of the first spring 400. The first spring 400 receives the outer profile of the axle 220 of the shaft 200. The stopper 610 of the second spring 600 engages the second spring seat aperture 740 of the first retainer 700. The second side 500B of the torsional spring 500 engages the recess 730 of the first retainer 700. The second stopper 410 of the first spring 400 engages the first spring seat aperture 720 of the first retainer 700. Additionally, or alternatively, the shaft 200 is inserted into the first side of the first spring 400. The first stopper 420 is adapted to engage the second side 210B of the flange 210.

The pulley 300 is adapted to rotate about the axle 220. For example, the outer surface of the axle 220 is intermeshed with the inner profile of the bearing 900 when the axle 220 is received by the pulley 300. The bearing 900 is adapted to allow the pulley 300 to rotate about the axle 220.

The profile of the inner bore 310 of the pulley 300 has a diameter that is larger than the initial coil diameter of the torsional spring 500, such that when the torsional spring 500 is in an initial position, the inner bore 310 is disengaged with the second spring 600, which constricts the torsional spring 500.

When the load on the pulley 300 increases, the pulley 300 accelerates in a first direction. The coil diameter of the torsional spring 500 increases and pushes the second spring 600 against the inner bore 310 of the pulley. For example, the initial coil diameter associated with the second spring 600 is smaller than the initial coil diameter of the torsional spring 500. The torsional spring 500 is wound up in a second direction that is opposite the first direction, such that when the angular velocity of the pulley 300 is higher than the angular velocity of the shaft 200 in a first direction, the coil diameter of the torsional spring 500 increases and presses the second spring 600 against the inner bore 310 of the pulley 300. The torsional spring 500 can be a torsional spring or other suitable springs. The second spring 600 locks the pulley 300, and the pulley 300 engages the first retainer 700 through the second spring 600. The first retainer 700 accelerates in a first direction with the pulley 300. The first spring 400 contracts and constricts against the axle 220. For example, the first spring 400 is wound up in the first direction, such that when the first retainer 700 accelerates in the first direction, the coil diameter of the first spring 400 decreases. The first retainer 700 engages the axle 220 of the shaft 200 through the first spring 400. The pulley 300 is engaged with the shaft 200 and transmits torque from the pulley 300 to the shaft 200. While the pulley 300 is driving the shaft 200, the damping characteristics of the second spring 600, the torsional spring 500, and the first spring 400 reduces and/or controls the vibration and noise generated by the vehicle engine and/or the alternator-pulley system, as described.

When the load on the pulley 300 decreases, the pulley 300 decelerates in a first direction. When the angular velocity of the shaft 200 is higher than the angular velocity of the pulley 300 in the first direction, the torsional spring 500 contracts and constricts against the first spring 400. The coil diameter of the second spring 600 is smaller than the diameter of the profile of the inner bore 310, such that the pulley 300 is disengaged from the first spring 400. The pulley 300 is connected to the shaft 200 through the bearing 900, such that the shaft 200 overruns the pulley 300.

In some embodiments, a one-way overrunning alternator clutch comprises: a first retainer that comprises an inner bore extending through the first retainer; a shaft that comprises a flange disposed at a first end of the shaft; an axle extending from a first side of the flange to a second end of the shaft, the second end of the shaft being opposed to the first end of the shaft, wherein the axle is adapted to be received by the inner bore of the first retainer; a first spring that comprises: a first end that engages a first spring seat aperture disposed on a first side of the first retainer; a second end that engages a second spring seat aperture disposed on a second side of the flange; and an inner bore extending from the first end of the second spring to the second end of the second spring that receives the axle of the shaft; a second spring that comprises: a first end that engages a first recess disposed on the first side of the first retainer; a second end that engages a second recess disposed on the second side of the flange; and an inner bore extending from the first end of the first spring to the second end of the first spring that receives the first spring; and a third spring that comprises: a first end that engages a third spring seat aperture disposed on the first side of the first retainer; a second end that engages the second side of the flange; and an inner bore extending from the first end of the third spring to the second end of the third spring that receives the first spring.

In some embodiments, a clutch comprises: a first retainer that comprises an inner bore extending through the first retainer; a shaft that comprises a flange disposed at a first end of the shaft; an axle extending from a first side of the flange to a second end of the shaft, the second end of the shaft being opposed to the first end of the shaft, wherein the axle is received by the inner bore of the first retainer; and a spring set disposed between the first retainer and the flange of the shaft, comprising: a first spring that receives the axle and comprises a first end that engages a first spring seat aperture disposed on the first side of the first retainer, the first spring being rotatable about the axle and having a coil diameter that is selectively adjustable between a first diameter and a second diameter that is larger than the first diameter; a second spring that receives the first spring, the second spring having a coil diameter that is selectively adjustable between a third diameter and a fourth diameter, wherein the fourth diameter is larger than the third diameter; and a third spring that comprises a first end that engages a second spring seat aperture disposed on the first side of the first retainer, and an inner bore that receives the second spring.

In some embodiments, a system comprises: a first retainer that comprises an inner bore extending through the first retainer; a shaft that comprises a flange disposed at a first end of the shaft; an axle extending from a first side of the flange to a second end of the shaft, the second end of the shaft being opposed to the first end of the shaft, wherein the axle is received by the inner bore of the first retainer; a second retainer disposed on a second side of the first retainer, opposite the first side, the second retainer comprising: a stopper disposed on a first side of the second retainer that engages a portion of the second side of the first retainer, wherein the stopper limits the relative rotation of the first retainer and the second retainer; and an inner bore that is adapted to receive the axle; a bearing disposed on a second side of the second retainer, opposite the first side, that comprises an inner bore that receives the axle; a pulley that comprises an inner bore extending through the pulley, wherein the inner bore receives the shaft, the first retainer, the second retainer, and the bearing; and a spring set disposed between the first retainer and the shaft, comprising: a first spring that receives the axle and comprises a first end that engages a first spring seat aperture disposed on the first side of the first retainer, the first spring being rotatable about the axle and having a coil diameter that is selectively adjustable between a first diameter and a second diameter that is larger than the first diameter, wherein the coil diameter of the first spring is adjusted from the second diameter to the first diameter in response to the relative rotation of the shaft and the pulley being in a first direction; a second spring that receives the first spring, the second spring having a coil diameter that is selectively adjustable between a third diameter and a fourth diameter that is larger than the third diameter, wherein the coil diameter of the second spring is adjusted from the third diameter to the fourth diameter in response to the relative rotation of the shaft and the pulley being in the first direction; and a third spring that comprises a first end that engages a second spring seat aperture disposed on the first side of the first retainer, and an inner bore that receives the second spring, wherein the third spring is adapted to engage the inner bore of the pulley in response to the second spring being in the fourth diameter.

As used herein, the term “or” is intended to mean an inclusive “or” rather than an exclusive “or.” That is, unless specified otherwise or clearly indicated otherwise by the context, “X includes A or B” is intended to indicate any of the natural inclusive permutations thereof. That is, if X includes A; X includes B; or X includes both A and B, then “X includes A or B” is satisfied under any of the foregoing instances. In addition, the articles “a” and “an” as used in this specification and the appended claims should generally be construed to mean “one or more” unless specified otherwise or clearly indicated otherwise by the context to be directed to a singular form.

Further, for simplicity of explanation, although the figures and descriptions herein may include components or elements of the system disclosed herein, the components or elements of the system disclosed herein may occur in various relative positions. Additionally, elements of the system disclosed herein may combine with other elements not explicitly presented and described herein. Furthermore, not all elements of the system described herein may be required to implement a system in accordance with this disclosure. Although aspects, features, and elements are described herein in particular combinations, each aspect, feature, or element may be used independently or in various combinations with or without other aspects, features, and elements.

While the disclosure has been described in connection with certain embodiments or implementations, it is to be understood that the disclosure is not to be limited to the disclosed embodiments or implementations but, on the contrary, is intended to cover various modifications and equivalent arrangements included within the scope of the appended claims, which scope is to be accorded the broadest interpretation as is permitted under the law so as to encompass all such modifications and equivalent arrangements.

What is claimed is:

1. An overrunning alternator clutch, comprising:
a first retainer comprising an inner bore extending through the first retainer;
a shaft comprising a flange disposed at a first end of the shaft;
an axle extending from a first side of the flange to a second end of the shaft, the second end of the shaft being opposed to the first end of the shaft, wherein the axle is adapted to be received by the inner bore of the first retainer;
a first spring comprising:
a first end that engages a first spring seat aperture disposed on a first side of the first retainer;
a second end that engages a second spring seat aperture disposed on a second side of the flange; and
an inner bore extending from the first end of a second spring to the second end of the second spring, the inner bore receiving the axle of the shaft;
the second spring comprising:
a first end that engages a first recess disposed on the first side of the first retainer;
a second end that engages a second recess disposed on the second side of the flange; and
an inner bore extending from the first end of the first spring to the second end of the first spring, the inner bore receiving the first spring; and
a third spring comprising:
a first end that engages a third spring seat aperture disposed on the first side of the first retainer;
a second end that engages the second side of the flange; and
an inner bore extending from the first end of the third spring to the second end of the third spring, the inner bore receiving the first spring.

2. The overrunning alternator clutch of claim 1, further comprising a second retainer disposed on a second side of the first retainer, opposite the first side.

3. The overrunning alternator clutch of claim 2, wherein the second retainer comprises:
a stopper disposed on a first side of the second retainer that engages a portion of the second side of the first retainer, wherein the stopper limits a relative rotation of the first retainer and the second retainer; and
an inner bore that is adapted to receive the axle.

4. The overrunning alternator clutch of claim 2, further comprising a bearing disposed on a second side of the second retainer, opposite the first side of the second retainer, wherein the bearing comprises an inner bore that receives the axle.

5. The overrunning alternator clutch of claim 1, further comprising a pulley comprising an inner bore extending through the pulley.

6. The overrunning alternator clutch of claim 5, wherein the pulley comprises a washer disposed in the inner bore of the pulley that receives the flange of the shaft.

7. The overrunning alternator clutch of claim 5, wherein the first spring is rotatable about the axle and is adapted to transmit torque between the first retainer and the shaft.

8. The overrunning alternator clutch of claim 5, wherein the second spring is adapted to push the third spring against the inner bore of the pulley in response to a relative rotation of the shaft, and the pulley is in a first direction and is adapted to disengage the third spring and the inner bore of the pulley in response to the relative rotation of the shaft and the pulley being in a second direction, opposite the first direction.

9. The overrunning alternator clutch of claim 8, wherein the third spring is adapted to engage the inner bore of the pulley and the first retainer in response to the relative rotation of the shaft and the pulley being in the first direction, and is adapted to disengage the inner bore of the pulley and the first retainer in response to the relative rotation of the shaft and the pulley being in the second direction.

10. A clutch, comprising:
a first retainer comprising an inner bore extending through the first retainer;
a shaft comprising a flange disposed at a first end of the shaft;
an axle extending from a first side of the flange to a second end of the shaft, the second end of the shaft being opposed to the first end of the shaft, wherein the axle is received by the inner bore of the first retainer; and
a spring set disposed between the first retainer and the flange of the shaft, comprising:
a first spring that receives the axle and comprises a first end that engages a first spring seat aperture disposed on the first side of the first retainer, the first spring being rotatable about the axle and having a coil diameter that is selectively adjustable between a first diameter and a second diameter, wherein the second diameter is larger than the first diameter;
a second spring that receives the first spring, the second spring having a coil diameter that is selectively adjustable between a third diameter and a fourth diameter, wherein the fourth diameter is larger than the third diameter; and
a third spring comprising a first end that engages a second spring seat aperture disposed on the first side of the first retainer, and an inner bore that receives the second spring.

11. The clutch of claim 10, further comprising a second retainer disposed on a second side of the first retainer, opposite the first side.

12. The clutch of claim 11, further comprising:
a stopper disposed on a first side of the second retainer that engages a portion of the second side of the first retainer, wherein the stopper limits a relative rotation of the first retainer and the second retainer; and
an inner bore that is adapted to receive the axle.

13. The clutch of claim 12, further comprising a bearing disposed on a second side of the second retainer, opposite the first side, wherein the bearing comprises an inner bore that receives the axle.

14. The clutch of claim 10, further comprising a pulley comprising an inner bore extending through the pulley.

15. The clutch of claim 14, wherein the pulley further comprises a washer disposed in the inner bore of the pulley that receives the flange of the shaft.

16. The clutch of claim 14, wherein the coil diameter of the first spring is adjusted from the second diameter to the first diameter in response to a relative rotation of the shaft and the pulley being in a first direction.

17. The clutch of claim 14, wherein the coil diameter of the first spring is adjusted from the third diameter to the fourth diameter in response to a relative rotation of the shaft and the pulley being in a first direction.

18. The clutch of claim 17, wherein the third spring is adapted to engage the inner bore of the pulley in response to the second spring being in the fourth diameter.

19. A system comprising:
a first retainer comprising an inner bore extending through the first retainer;
a shaft comprising a flange disposed at a first end of the shaft;
an axle extending from a first side of the flange to a second end of the shaft, the second end of the shaft being opposed to the first end of the shaft, wherein the axle is received by the inner bore of the first retainer;
a second retainer disposed on a second side of the first retainer, opposite the first side, the second retainer comprising:
a stopper disposed on a first side of the second retainer that engages a portion of the second side of the first retainer, wherein the stopper limits a relative rotation of the first retainer and the second retainer; and
an inner bore that is adapted to receive the axle;
a bearing disposed on a second side of the second retainer, opposite the first side, comprising an inner bore that receives the axle;
a pulley comprising an inner bore extending through the pulley, wherein the inner bore receives the shaft, the first retainer, the second retainer, and the bearing; and
a spring set disposed between the first retainer and the shaft, comprising:
a first spring that receives the axle and comprises a first end that engages a first spring seat aperture disposed on the first side of the first retainer, the first spring being rotatable about the axle and having a coil diameter that is selectively adjustable between a first diameter and a second diameter that is larger than the first diameter, wherein the coil diameter of the first spring is adjusted from the second diameter to the first diameter in response to a relative rotation of the shaft and the pulley being in a first direction;
a second spring that receives the first spring, the second spring having a coil diameter that is selectively adjustable between a third diameter and a fourth diameter that is larger than the third diameter, wherein the coil diameter of the second spring is adjusted from the third diameter to the fourth diameter in response to the relative rotation of the shaft and the pulley being in the first direction; and
a third spring comprising a first end that engages a second spring seat aperture disposed on the first side of the first retainer, and an inner bore that receives the second spring, wherein the third spring is adapted to engage the inner bore of the pulley in response to the second spring being in the fourth diameter.

20. The system of claim 19, wherein the third spring disengages the inner bore of the pulley in response to the second spring being in the fourth diameter.
